(19) United States
(12) Patent Application Publication
(10) Pub. No.: US 2022/0000262 A1
(43) Pub. Date: Jan. 6, 2022

(54) CONNECTOR AND BRACKET

(71) Applicant: Process Displays LLC, Minneapolis, MN (US)

(72) Inventor: Rick D. Anderson, Minneapolis, MN (US)

(21) Appl. No.: 17/150,651

(22) Filed: Jan. 15, 2021

Related U.S. Application Data
(60) Provisional application No. 63/034,768, filed on Jun. 4, 2020.

(51) Int. Cl. A47B 57/42; A47B 47/02; A47B 96/02; A47F 5/10

(52) U.S. Cl. CPC A47B 57/42; A47F 5/103; A47B 96/028; A47B 47/022

(57) ABSTRACT

The present invention relates to a multi-purpose connector, and a bracket that can be fitted into the slots of a gondola, including gondolas used to store and display goods in a retail environment.

### RELATED APPLICATIONS

The present application incorporates by reference U.S. Provisional Patent Applications Nos. 63/034,768 filed on Jun. 4, 2020.

### BACKGROUND OF THE INVENTION

### Field of the Invention

The present invention relates to multi-purpose connectors and brackets, and more particularly to connectors for use with merchandise display fixtures. Of course, a person of ordinary skill in the art will understand that the invention is not necessarily so limited.

### Background

In many environments, including retail store spaces, a variety of materials are commonly affixed within the open space therein. In particular, in retail environments this include shelving for goods, and space for promotional and marketing displays used with various goods. Conventionally, these materials, which can include posters, displays, products, brackets, hardware, or other materials, are affixed to a backing adapted for repeated display and removal of the items.

A common type of shelving is referred to as a pegboard gondola (see FIG. 1), which consists of a durable pegboard material with a pattern of perforations located in a predetermined pattern fixed to a footing and used for display and attaching product shelving, products, and advertising materials and displays associated with the sale of goods (like posters, backing material, and other displays). Connectors, fasteners, or brackets are designed to attach to the gondola in a secure and releasable manner to facilitate the foregoing. Also, due to the fact that these displays are frequently changed the connectors and fasteners must be capable of removal to allow for such updates and changes to the goods and displays.

A variety of prior art connectors exist. These include a device having a generally flat head connected to an extended body that is sized to be captured in the spaced apart holes of the pegboard. If display material is attached to the gondola, then the connectors pass through holes in the material to be displayed and then the connectors fasten into the pegboard and thereby provide a reasonably stable mounting mechanism. Such connectors include so called “canoe clips.” The head of the clip is flat without any indentations or grooves for removal. In fact, the clips do not include any particular structural elements to allow for removal. When the display is replaced the clips are pulled or pried out of place, normally destroying the clip and damaging the hole in the peg board in the process. The clips are thrown away and new clips are used for the next display. In this manner the clips are disposable and not suitable for reuse, and can damage the holes they are inserted into, eventually ruining the gondola.

Another such device is the “Christmas tree clip.” These clips also contain a head and body, however, in this case the body includes a plurality of teeth circularly disposed around the axis of the body, each tooth comprised of a circumferential flange angled to resist removal after insertion into the pegboard. Again, the clips do not include any convenient means for removal, and are therefore designed for one-time disposable use, and can damage the holes when removed.

While these prior art clips are generally inexpensive plastic articles, ultimately the cost of continued replacement of used clips becomes very significant. Furthermore, the environmental impact of disposable clips is detrimental. Additionally, because these clips are not designed to be removed easily, over time they damage the pegboard and the gondola, requiring further costs and expense.

Another use of such clips is to assemble displays, and in particular assembly of cardboard or corrugated display material. One such prior art device is known as the “Viking clip,” which is comprised of plastic and consists of a flathead screw with a nut or wing nut that affixes to the threaded body of the screw. The threads are minimal, and have a diameter less than the diameter of the hole. The Viking clip, however, requires manipulation from both sides of the assembly since the nut must be placed on the screw after the screw is placed through the hole in the assembly. Frequently, given the size of the assemblies, this requires two people to perform the assembly—one in the front and one in the back to affix the nut.

Additionally, gondolas include stanchions or posts located at the perimeters with the pegboard attached therebetween. The stanchions have spaced apart slots that are used for attachment of shelves (See FIGS. 1, 2); however, heretofore the stanchion slots have been used in only limited ways. Other elements of the gondola such as the edges at the ends of the gondola, which form the end caps, have not been used for application of connectors or brackets.

Accordingly, a need exists for a device to better utilize the gondolas, stanchions, and other surfaces.

### BRIEF DESCRIPTION OF THE FIGURES

FIG. 1 shows a perspective view of a prior art gondola.

FIG. 2 shows a close up view of the portion of the gondola shown in the circle in FIG. 1.

FIG. 3 shows a side view of a connector.

FIG. 4 shows an end view of the connector.

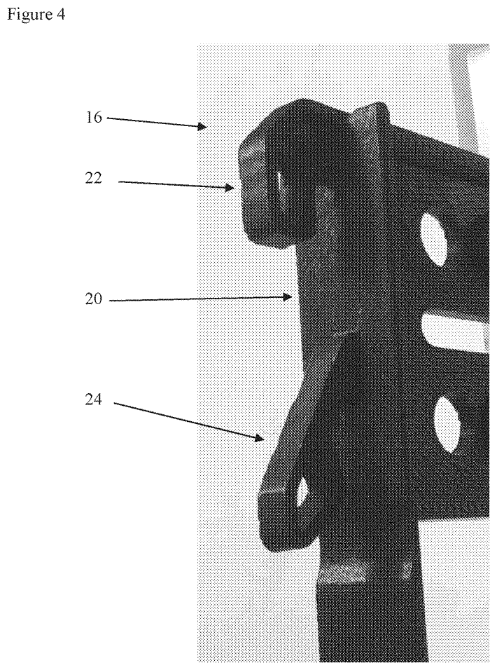

FIG. 5 shows a side view of the connector with a bracket attached thereto.

FIG. 6 shows an end view of the connector and bracket of FIG. 5.

FIG. 7 shows multiple views of a connector.

FIG. 8 shows multiple view of a connector.

FIG. 9 shows a perspective view of a connector.

FIG. 10 shows a view of the connector shown in FIG. 9 with the sides detached.

FIG. 11 shows multiple view of a fixture.

FIG. 12 shows a perspective view of a connector.

FIG. 13 shows the connector shown in FIG. 12 with the side and body separated.

FIG. 14 shows a top view of the connector of FIG. 12.

FIG. 14 shows multiple views of a fixture.

### DETAILED DESCRIPTION OF THE INVENTION

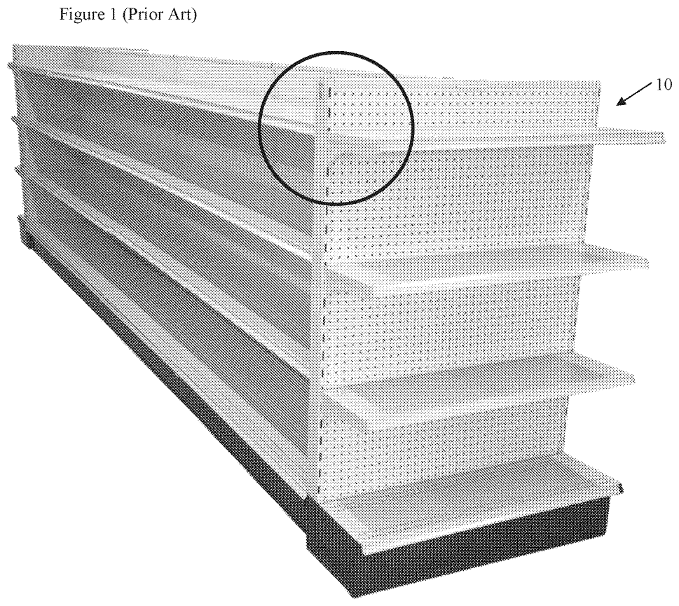

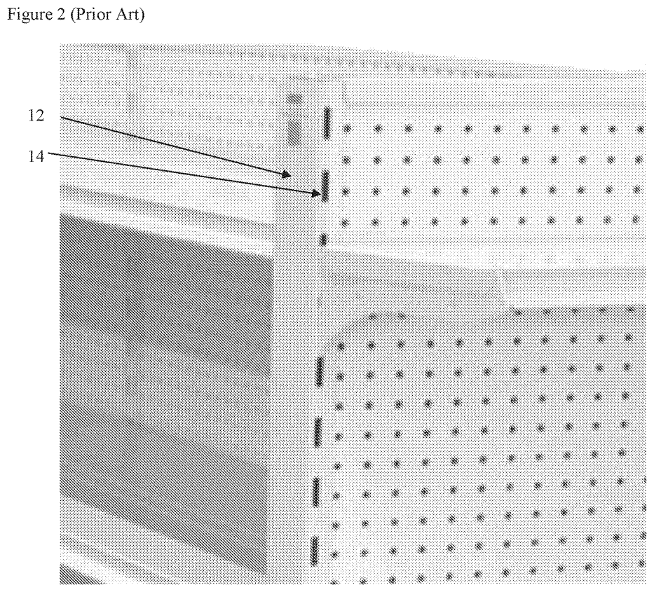

FIGS. 1 and 2 show a prior art gondola 10, which is commonly used for storage and display of goods in retail and other environments. The gondola 10 includes a number of stanchions 12 comprised of vertical rails that form part of the frame of the gondola 10, particularly at the ends of the gondola 10. The stanchions 12 have a plurality of slots 14. Pegboard forms a backing, and the gondola 10 is supported by footings. Shelving can be attached through the slots 14 in the gondola 10 as shown in FIGS. 1 and 2.

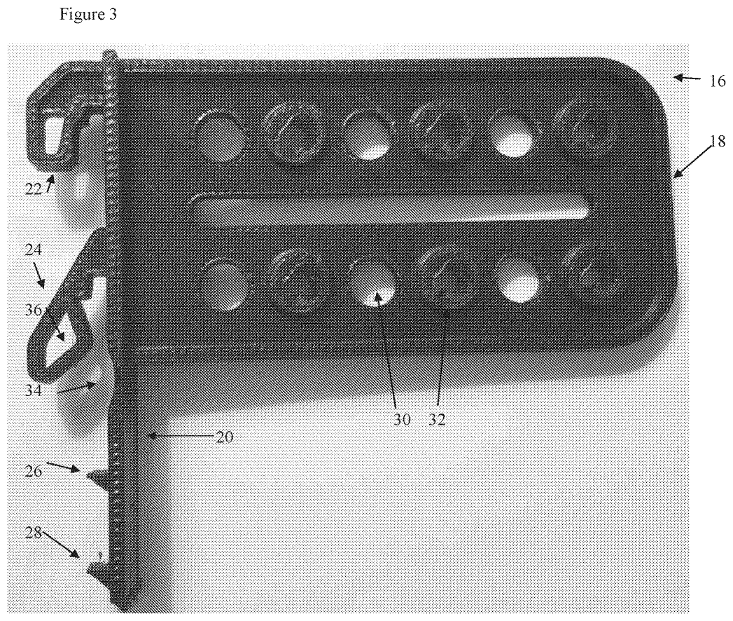

FIG. 3 shows a connector 16 of the present invention. The connector 16 comprises a bracket 18, and a stem 20 extending along and below one side of the bracket 18. The stem 20 includes an upper hook 20 and a lower hook 24. The lower part of the stem 20 includes an upper barb 26, and a lower barb 28. The bracket 18 includes a plurality of holes 30, and threaded holes 32.

The connector 16 connects to the slots 14 of the stanchion 12 of the gondola 10. The upper hook 22 fits into one slot 14, and the lower hook 24 fits into a slot 14 immediately below the slot 14 into which the upper hook 22 fits. The upper barb 26 fits inside an upper edge of a slot 14 below the slot into which the lower barb 24 fits, while the lower bard 28 fits inside a lower edge of the same slot 14.

The lower hook 24 includes a spring section 36, which is biased against the inside of the slot 14 of the stanchion 12 when the connector 16 is inserted, to assist in retaining the connector. The stem 20 includes a curved section 34 that, when the connector 16 is inserted into the slots 14 of the stanchion 12, aligns with a lower edge of a slot 14 to allow the connector to fit into place and more easily be removed and inserted.

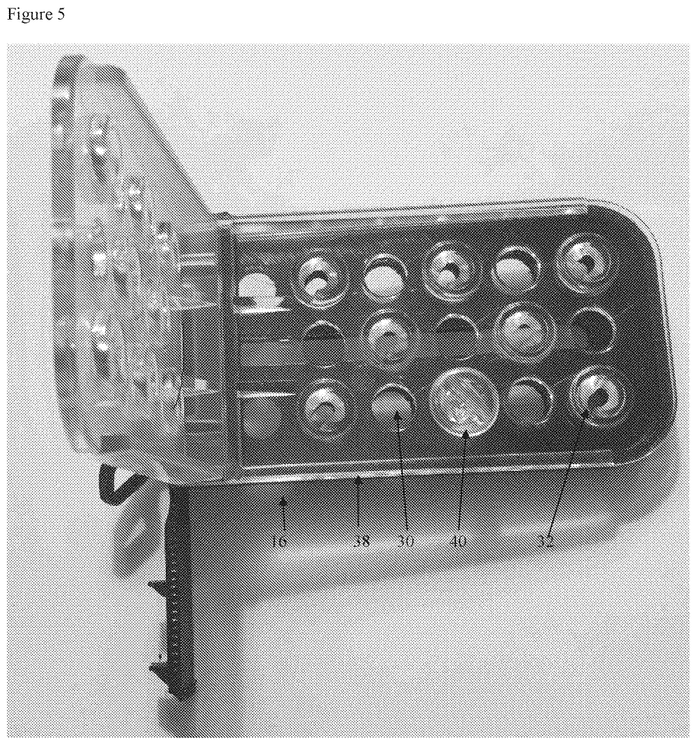

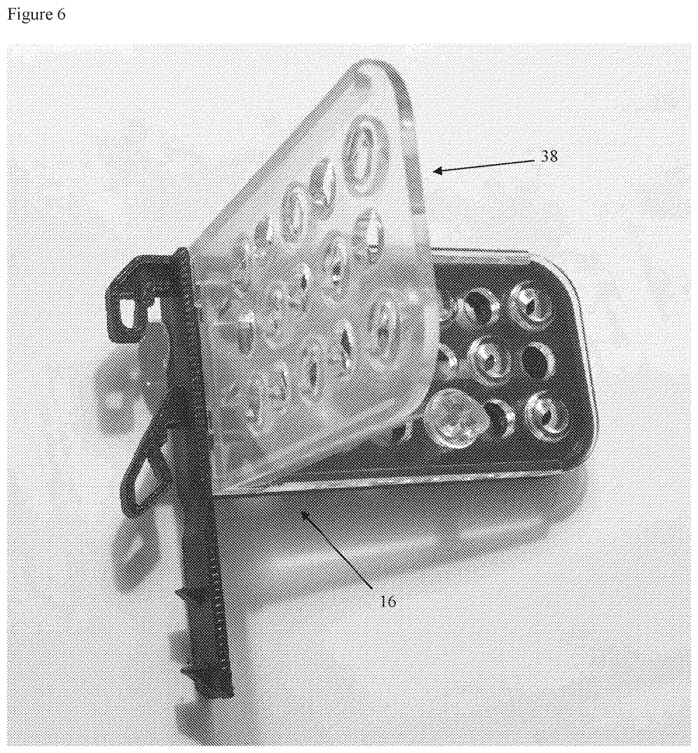

FIGS. 5 and 6 show the connector 16 with an L-bracket 38 attached thereto. The L-bracket 38 has two sections that join at a right angle to form the L-shape. The L-bracket 38 include holes 30 and threaded holes 32 on both of the sections. The L-bracket 38 is attached to the connector 16 with a screw 40 that threads through the threaded holes 32 in the L-bracket 38 and the threaded holes 32 in the connector 16.

The threaded holes 32 include slightly less than one full turn of a thread. This allows the connector 16 and L-bracket 38 to be produced with an open molding process, as opposed to a closed molding process. With open molding the molding material is open to the air and can cure quickly. If the thread is much more than one full thread, then it cannot be produced using open molding and must be closed molded, which increases the cost and time necessary to produce these items.

The bracket 16 as described can be easily attached and detached from the gondola 10, and provides structure to which other elements can be attached (such as the L-bracket 36), through the holes 30, 32—either with the use of screws 40 or other devices like a bolt and nut. The holes 30, which do not have threads, are provided for this purpose as well as for connectors that need to pass through the bracket 16 and/or the connector 38. This creates the ability to easily attach display materials, storage items, or build a frame for creating dimensional structures used in connection with the gondola 10. This is especially the case in retail environments, where the goods displayed or stored on the gondola 10 change frequently, as do the advertising and informational material associated therewith.

The threaded holes 32 are adapted for use with screws of the type described in U.S. Provisional Patent Applications Nos. 63/034,768, referenced above, which have a unique design that allows the screws to snuggly pressure fit into place without damaging the material into which they are inserted.

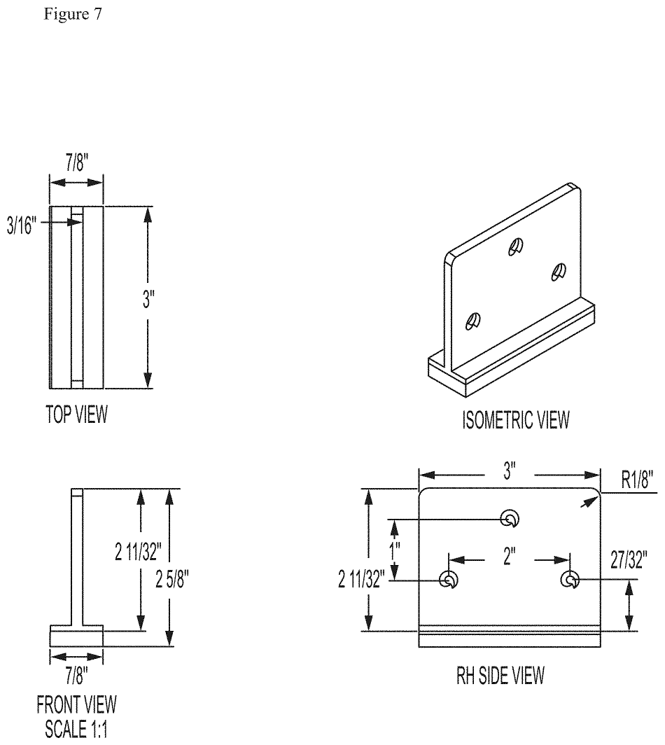

The present invention includes additional connectors, including the connector shown in FIG. 7. FIG. 7 shows multiple views of a T-slot connector that has a rectangular base and an upright center section. The center section has a plurality of threaded holes 32 (such as shown in FIG. 3 and other Figures). The base of the connector is magnetic and secures to magnetically to suitable surfaces such as the edges of the gondola 10. The base is typically an inch wide for that purpose, but can vary in size. Once secured, material can be attached to the connector such as signs posters, flyers, dimensional material, and the like using the screws inserted through the materials and into the connector threaded holes. Nuts can be affixed to the screw from the back of the connector.

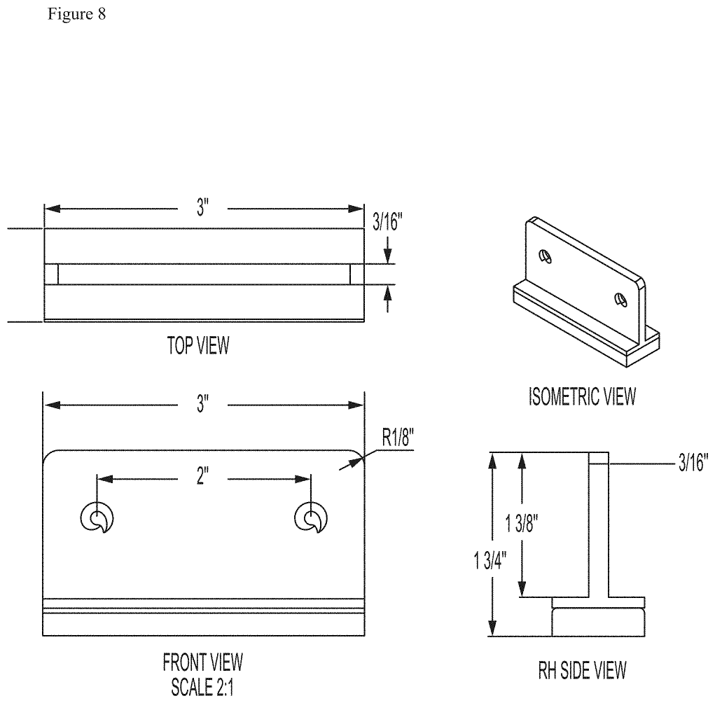

FIG. 8 shows a magnetic connector similar to the connector of FIG. 7, but smaller having two threaded holes and a shorter upright section, but otherwise the same in use and construction.

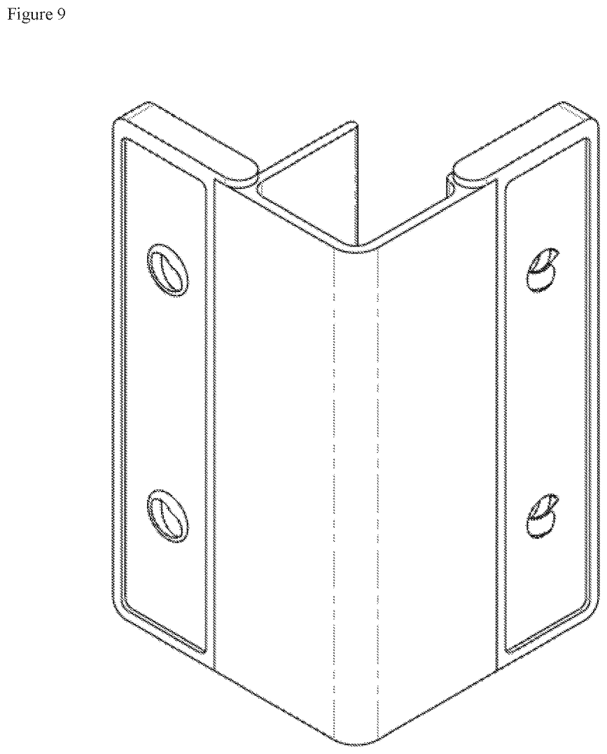

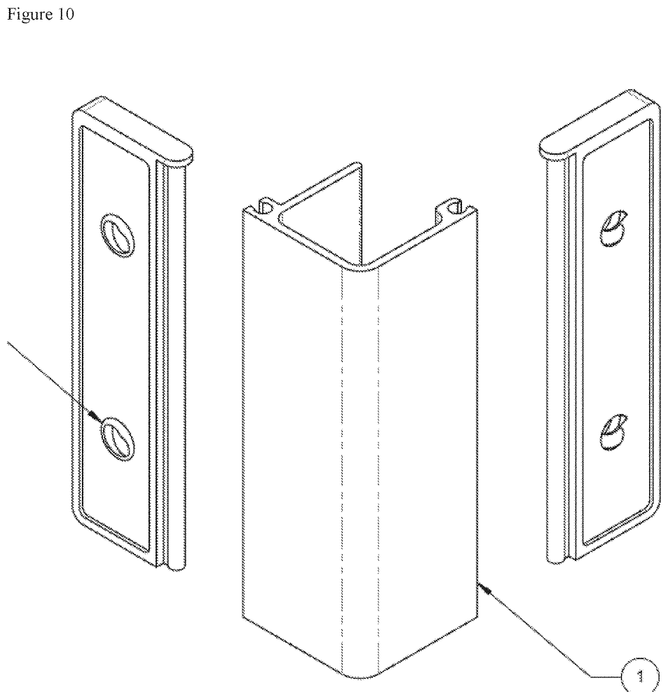

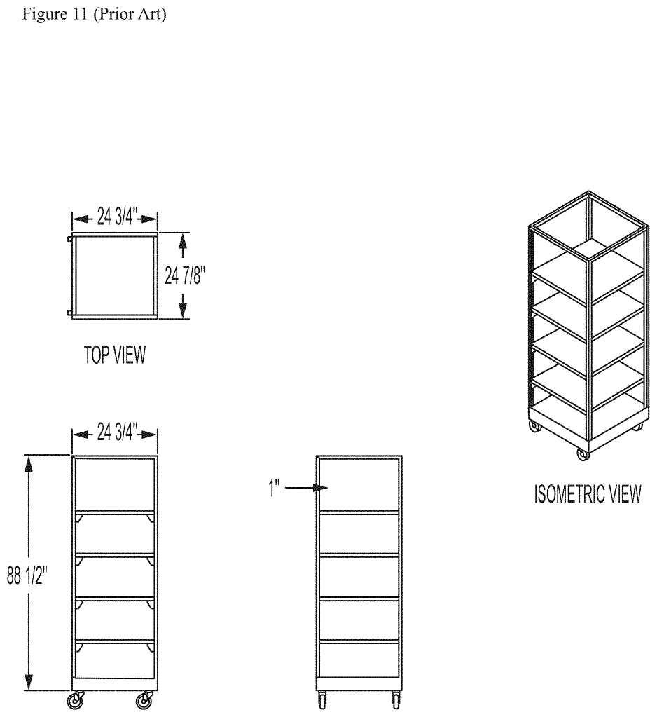

FIGS. 9-10 shows a connector that comprises a center body and two side pieces. Each side piece includes a ridge that either slides, or snap fits, into an opposing channel along the edge of the body. The ridge on the side pieces has a cap at the top (the bottom end has no cap). The cap acts as a stop hitting the top of the channel of the body of the connector. The side pieces can be moved to either side of the body allowing them to slide in from the top or the bottom of the body as desired. The connectors of FIG. 9-10 can be used with a number of fixtures, including the gondola 10, however, they are particularly adapted for use with the tower fixture shown in FIG. 11.

The body of the connector has two flanges with a gap therebetween such that the connector can snap fit onto perimeter members of the fixture—clamping the member between the flanges. The members are generally one inch by one inch in size, and the gap between the flanges is sized accordingly (different sizes can be accommodated). The sides included threaded holes 32 to allow various materials to be connected using screws as described above.

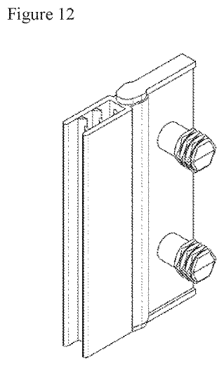

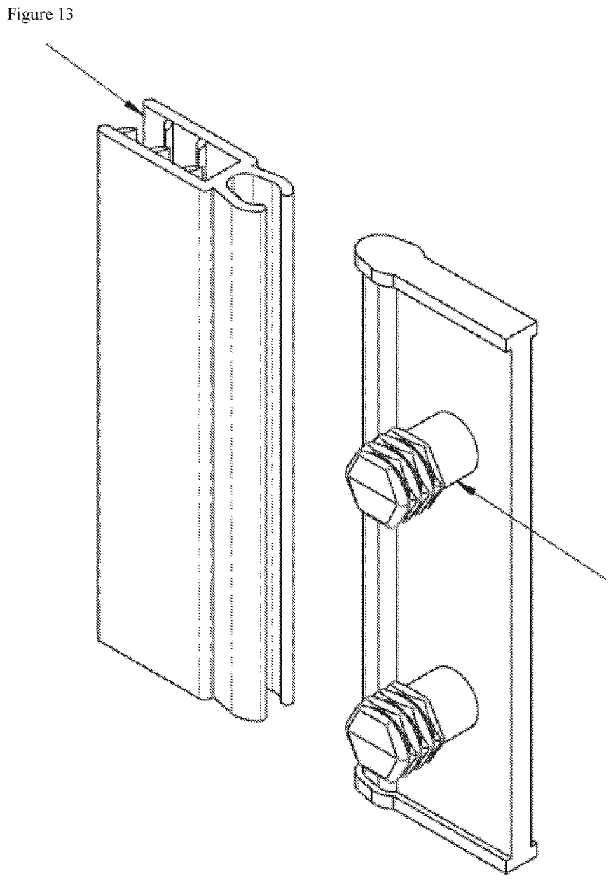

FIGS. 12-14 show a connector having a body and a side piece. The body includes a channel that mates with a ridge on an end of the side piece. The channel can snap fit onto the ridge of the side piece, and the side piece has caps at the top and bottom that act to stop the channel on the body from moving up and down when snapped into place. The side piece comprises two threaded studs, that can be used to attach materials included a threaded nut or other threaded structures to retain the materials, or to create a dimensional composite structures. The side piece can be turned 180 degrees to allow the threaded studs to move from one side to the other. The studs are useful in situations where there might not be space to easily insert a screw, or for other reasons.

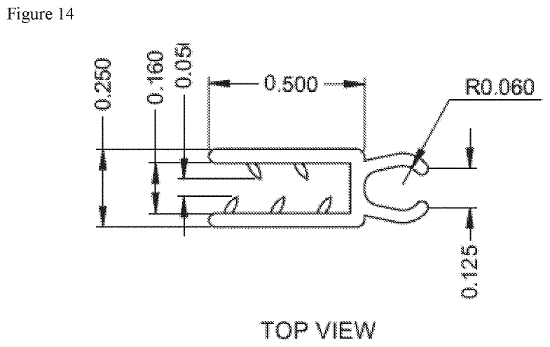

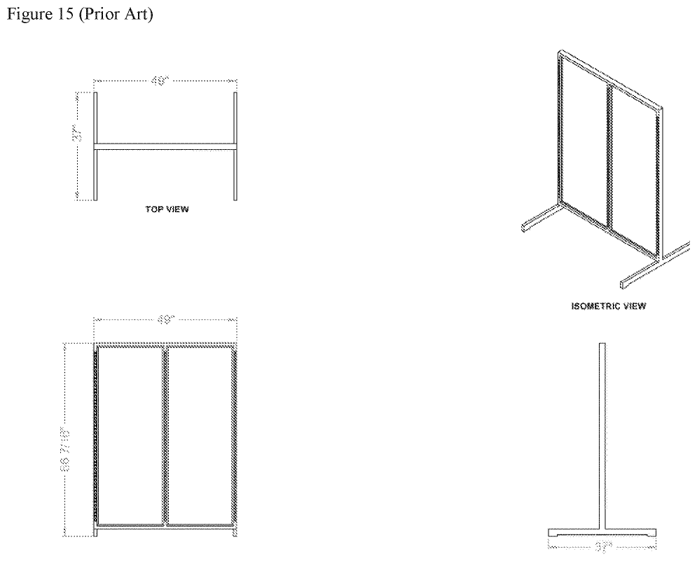

The channel further comprises an elongated channel opposite to the channel that snap fits to the side piece, for mounting the connector to a fixture. The elongated channel has internal barbs (see FIG. 14) that run the length of the channel pointing inward to assist in retaining the connector in place after it is fitted to the fixture.

The connector can be used with a variety of fixtures (including the gondola 10), but is particularly suited for use with the fixture shown in FIG. 15, which is comprised of a frame with open panes, where the connector can be attached to any of the frame members. The connector can also be used with any sheet metal fixture.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The above specification and accompanying Figures are for illustrative use only. The scope of the present invention is defined by the following claims. The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A connector for connection with a slots in a fixture, comprising:
a bracket;
a stem connected to the bracket; and
at least one hook for releaseably securement in the slot of the fixture.

2. The connector of claim 1 where the bracket has a plurality of holes.

3. The connector of claim 2 where some of the holes are threaded and some are not.

4. The connector of claim 1 where the hook further comprises a spring biased to retain the connector in the slot.

5. The connector of claim 1 comprising two hooks for releasable securement to two slots of the fixture.

6. The connector of claim 5 where one hook inserts further into the slot than the other.

7. The connector of claim 1 where the stem includes barbs that engage with slots of the fixture.

8. The connector of claim 1 where the stem further comprises a curved section to reduce the tension of inserting the hooks into the slot of the fixture.

9. The connector of claim 3 where the threaded holes each include slightly less than one full thread.

10. The connector of claim 3 where the bracket comprises a first bracket and further comprising a second bracket with holes that secures to the first bracket.

11. The connector of claim 10 where the first and second brackets are secured with a screw that inserts into threaded holes in the first and second bracket.

12. The connector of claim 10 where the second bracket as a first section that secures to the first bracket and a second section that secures to the first section.

13. The connector of claim 12 where the first section and second section of the second bracket secure at right angles.

14. The connector of claim 12 where the second section of the second bracket has a plurality of holes some of which are threaded and some are not.

15. A connector for connection with a slots in a fixture, comprising:
a first bracket having a plurality of holes where some of the holes are threaded and some are not, and the threaded holes have slightly less than one full turn of a thread;
a stem connected to the bracket where the stem has barbs that secure to slots in the fixture, and has a curved section to reduce the tension of inserting the hooks into the slot of the fixture;
a first hook and a second hook for releaseably securement in the slots of the fixture, where at least one hook has a spring section biased to retain the hook in the slot, and where one hook fits further into a slot than the other hook;
a second bracket having a first piece and a second piece where each piece has holes where some of the holes are threaded and some are not, and the threaded holes have slightly less than one full turn of a thread, the second bracket securable to the first bracket with screws, and the first and second pieces of the second bracket forming a right angle with each other.
